(19) United States
(12) Patent Application Publication
(10) Pub. No.: US 2009/0258689 A1
(43) Pub. Date: Oct. 15, 2009

(54) No dealer hand "21"

(76) Inventors: J. Richard Hedge, JR., Oro Valley, AZ (US); Aviva R. Hedge, Oro Valley, AZ (US)

Correspondence Address: J. RICHARD HEDGE, JR., 2206 E. STONE STABLE DRIVE, ORO VALLEY, AZ, 85737, US

(21) Appl. No.: 12/082,464

(22) Filed: Apr. 11, 2008

(51) Int. Cl. A63F 1/00; A63F 13/00; A63F 9/24; G06F 19/00

(52) U.S. Cl. 463/12; 273/292

(57) ABSTRACT

A process for playing “no dealer hand” Twenty-one is established where the uses of, or display of, at least one common deck of fifty-two cards is being applied for play action. This process is inclusive to either an encompassing video gaming apparatus or a live action table gaming environment, as accommodated for. In play action, the dealer's hand is replaced with the application of Trigger Numbers, ranging anywhere from Twelve (12) up to Twenty (20), and optional Push Numbers ranging anywhere from Twelve (12) up to Twenty (20). Through such an application, a more mathematically malleable and “broader core margin” percentage variance is provided for exploitation. Likewise, this broader core margin variance is made possible while simultaneously applying a seamlessly familiar playing experience for patrons. In so doing, the applicants' Trigger & Push Number solutions replacing the dealer's hand in play action, proffers a whole new frontier for the “Twenty-One” gaming procedure. As such, this procedure directly features significantly fatter core payoffs for winning hand tallies from the game's base mathematical mechanics for play while still providing for all the necessary elements of a sustainable alternative to the classic Blackjack workhorse for which the public can enthusiastically embrace.

### FIELD OF INVENTION

This invention relates to games of chance as historically identified with wagering in casinos.

The applicants' methods and modifications are inclusive to both a variety of live action table gaming formats as well as electronic display applications for play, of all types.

Their inventive process utilizes at least one common deck of fifty-two (52) playing cards or the electronic simulation of the like to be specific. Also, the present invention utilizes a process formulated upon the “absence of a Dealer hand” throughout the game's course of play.

In action, this absence of a Dealer hand is without precedent to the traditional/classic play of Blackjack in all of its present day forms and permutations. In so teaching, the applicants' methods proffer a whole new paradigm of opportunity for “21” play within the applicants' applied industry of casino gaming.

Moreover, a quick, simplistic method of card play is provided for players looking for a fun, entertaining time wherein a reasonable chance of winning may be had. Presently, the applicants' know of no previously established methodologies regarding either “live action” table game embodiments of Blackjack/21, including those banked by a house (casino) or electronic “virtual reality” display methods of Blackjack/21 either with or without dealers, which are presently under Patent enforcement or otherwise, that might be construed as teaching on or reading upon their concepts and process of play.

### DESCRIPTION OF PRIOR ART

Blackjack is a centuries old game and historically the premier table game in American casinos as well as casinos across the world.

No doubt there is good reason for this. America and the world, love card games and they know this game—Blackjack!

Actually, it's a love/hate relationship just ask anyone who plays the game. People love to play Blackjack especially when the cards give, and of course, take. But no one, in any language, enjoys getting slaughtered when the dealer stays so “hot” that just simply nothing the player does is right!

But, before the disclosure of the applicants' alternative methodologies, a basic discussion regarding Blackjack's traditional play along with its terminology and historical trends is useful in teaching the applicants' inventive process as described and illustrated further below. Simply put, the objective in traditional Blackjack is to beat the dealer's hand. This is accomplished by having a totality of cards that tally higher than the dealer's cards without going over 21.

The card values in Blackjack are as follows: Cards Two (2) through Ten (10) are tallied at face value while “Face cards” are valued at Ten (10) and Aces are valued at Eleven (11) or One (1). Likewise, from here forward, the term “Ten card” will define both Ten (10) cards and/or Face cards. Similarly, a “Blackjack” hand is always made up of the first two cards dealt. These cards being, a Ten card and an Ace. The Blackjack hand is also referred to as a “Natural” or when made with three (3) or more cards a “21”, and is just as generally unbeatable.

Although, the dirty fact of the game is that a dealer's Blackjack will often “Push” a player's Blackjack hand (meaning the player's hand doesn't win or lose).

This “Push/Tie” outcome situation also provides a constant 9% advantage to the house. Likewise, a dealer hand 21 made with three (3) or more cards Push all player's hand 21's made with three (3) or more cards as well. As a practical matter, a player can win with any total under 21, so long as the dealer “Busts” first.

Busting in Blackjack/21 is any final tally higher than Twenty-One (21) for either the player's or the dealer's hand. But, unlike the dealer, players will experience the “Double Bust”. The Double Bust occurs when players Bust-out first, followed by the dealer Busting.

It is this constant reality of the Double Bust by which players are intractably facing in Blackjack that gives the casino its greatest most frequently exercised “House Percentage Advantage” (a.k.a. “Vig” or Vigorish) over the players. It is said that the dealer and the players will Bust 28% of the time. But again, only the players can experience the Double Bust because the players must act first!

All things being equal, Double Busting provides the house with a constant 5.7% advantage over the players when Double Busting occurs. Therefore, anyway you play it, within the confines of all traditional “Dealer hand” methods and rules for playing Blackjack/21, there remains a powerful house advantage being exacted against all players within the traditional rules of Blackjack, which must be constantly evaded. This house advantage is the Double Bust effect. Furthermore, it should be remembered, as if this Double Bust effect was not enough, the house pushes on ties, so therefore wins all Ties too! Simply put, they did not pay on 21, so they won . . . .

Additional aspects of traditional Blackjack play include the terminology of “Hard”, “Stiff”, “Soft” and “Pat” hands. A Hard hand is one that either does not have an Ace: 9-7/16 or if it does, it tallies as a 1; 9-6-A/16. Typically, any Hard hand that totals 12 thru 16 is also called a Stiff hand because it can easily Bust when drawing additional cards.

A Soft hand is one that has an Ace being tallied as Eleven (11) amongst the first Two (2) cards being dealt: A-6/17, A-7/18, A-8/19 or A-9/20. Regardless of whether the player's hand stands made upon a Hard or Soft 17, 18, 19 or 20, such hands are thought of as Pat hands.

### DESCRIPTION OF THE PRIOR ART

The last two general strategies of traditional Blackjack play include card “Splitting” and/or “Doubling Down” both practices of which players are well advised to partake of, though tableside restrictions will vary from house to house.

Most often when players engage the practice of card Splitting & Doubling down, the decision is simply weighed against the dealer's “Up-card”. Should the dealer's Upcard be a Bust card: 3, 4, 5 or 6, this often inclines the player to Split their paired cards, such as: 6's, 7's, 8's, 9's or Aces, when they otherwise may not.

This scenario facilitates a great Splitting opportunity or better yet, as paired Aces reveal, a fantastic multiple Double Down action against a dealer's weak Upcard. Although, players may draw out as many cards as necessary in a normal card Splitting situation until they either Stand Pat or Busts! Similarly, when Splitting Aces, many casinos allow only One (1) card for each split Ace.

In further regards to Doubling Down, it's a good idea to Double Down whenever the opportunity arises. Although, Doubling Down is sometimes restricted to a player's first Two (2) cards tallying 10 or 11 only. Moreover, many restrictive rules especially those pertaining to Splitting & Doubling Down are put into place by housemasters, as a means to maintain a desired core operating margin position for their Blackjack games therein, benefiting their casinos. Therefore, these rules will vary based on many subserviently subjective factors. Additional subservient factors are found within the “Insurance” & “Surrender” rules as historically applied.

Traditionally, Insurance is offered when the dealer's Upcard is an Ace. For the unwashed, Insurance is generally thought of as a “bad bet”, but does protect the player's wager in the event the dealer has Blackjack with a Ten hole card. As for the traditional practice of the Surrender rule option (where it is still found), this rule enables the players to withdrawal from the hand for half the original contract wager.

This action is taken by player(s) when it's felt the dealer's hand is so strong (often repeating Up-card Aces) that keeping half the original contract wager is clearly better than losing all of it. In America today and throughout the world, Insurance is readily found as part of the Blackjack gaming scene where Surrender rules are not so readily found outside of Asia and Europe.

The reasons are simple. Insurance is generally thought of as a bad wager for players to engage in while Surrendering against a continually “hot” dealer hand generally is a good idea. Of course, the Surrender action as historically deployed assumes the player is not motivated to just simply get up and leave . . . .

Furthermore, the above background rendering of traditional Blackjack/21 rule play, pretty much covers all the essential bases. Although, there still remains the dubious issue of card counting, as well as the speculative issue of “Ante” wager side-betting, that has so proliferated the world in resent years. Card counting is the fastest growing somewhat “under the radar” trend of classic Blackjack.

Moreover, this encroaching advance against the rather thin house advantage of the classic game of Blackjack, via the art of card counting, has become so pervasive in recent years that a new and rather deleterious trend around the Blackjack tables in Las Vegas and around the country is to pay a Natural Blackjack at: 6 to 5 over the traditional Blackjack pay off of 3 to 2.

Worse yet, this surreptitiously defensive trend is spreading fast and will prove extremely disadvantageous to both the “stout Blackjack players”, and the more “profligate to-smart-by-half type weekend players” alike!

Therefore, a general discussion regarding the salient points and trends of card counting is useful in understanding additional motivations of the applicants'modified methodologies. Effective card counting by way of the amateur or professional is steeped in process memorization. The memorization of fixed strategy tables often referred to as indexes, to be specific.

In action, it is the memorized strategy tables counseling within the minds eye of a basic “Hi-Lo” trend counts that provide the “edge” that bares the winning advantage so sought after by Blackjack connoisseurs.

The Hi-Lo trend count starts at zero upon a new shuffle of a single deck or multi-deck shoe. A shoe is the mechanism from which the dealer advances individual cards up to a multiple of 8 decks of 52 cards.

Therefore, unlike Dice or Roulette, Blackjack is made up of a series of “dependent trials” culminating in hands. As such, each “card value” being seen affects the likely outcome of the next card, and so on.

So, in assigning numeric count values to cards leaving the shoe, the low cards: 2, 3, 4, 5 or 6 are counted as +1 and all high cards: 10, J, Q, K or A are counted as −1. All 7, 8 & 9 cards are ignored in the basic Hi-Lo trend method while the Half-count methodology is significantly more cumbersome for the individual, but is known to be even more effective especially when a “deep penetration” of the shoe occurs.

Although, as aforementioned, there can be up to 8 decks of cards in a shoe, albeit a smart card counter restarts their counts from the ensuing flow of discarded cards One (1) deck at a time throughout the play of the shoe. This action subsequently results in the “true count” or tracking of the shoe.

Suffice to say on the one hand, it's been observed that for the “stout” Blackjack player the main purpose for acquiring the skill and confidence that card counting promises is to know when to “hit” to improve a Stiff hand, or better yet, to pitch the dealer Bust cards.

Although, for the largely reckless card counter, what card counting is probably best suited for is avoiding the dreaded Double Bust effect, as well as evaluating both Insurance plays and Surrendering wherever allowed and whenever it's wise. For these skills alone will save “profligate” weekend players a bundle against a casino full of scorching hot dealers!

On the other hand, for today's professional, this basic skill set would likely be closely augmented by more precipitous methodologies like the “Half-count” method, the HI-OPT and HI-OPT II method or the KO plus “Ace tracking” method to name just a few, that most Blackjack card counting connoisseurs esteem for, assuming their mental acuity can remain sharp enough.

In the end, the edge that quality card counting provides is that minds-eye intuitive impetus to “make the play”, and for the very rare breed of gambler, that strong pulling back counter intuitive perspective that can largely see ahead, with 20/20 hindsight!

Now, if this all sounds a bit over the top, maybe it is, and then again, maybe its not?
After all, this is a game that now finds a growing number of tables paying Naturals at: 6 to 5.

### DESCRIPTION OF THE PRIOR ART

Therefore, a significant “redress” of this old favorite could well prove most timely . . .

To this end, given the demanding yet, fickle nature of housemasters (casino management) qualifying a comprehensive redress in the form of a new “top down” rendition, for the classic game of Blackjack, will prove tricky. Casino games, especially well established games, evolve ever so slowly due to the rather strident, change resistant nature of housemasters, where their table games are concerned.

Just look at Craps' “stats” for the last 20 plus years or Hazard & Faro before that. What eventually dissipates as a game ages is the must have public's participation to maintain steady “Drop values” (the players cash buy-in), in significant enough numbers as to support a viable Win% value for the games continued survival.

It is equally true that casino games must simultaneously “exercise & balance” their must have “Vig-percentage advantage” over players in wide enough margins while achieving the most viable Win % value possible from the games they run.

Another words, to accomplish this, any new gaming solution entering the casino floor must be very quick to learn, and be “fat enough in the math” to allow winners while nurturing the necessary Win % value required for a productive bottom line Hold % for the casino.

And, though all this in itself is a tall order, a game design that meets these tests by the very basis of its methodology is a real plus, a real big plus! The simple “rule of thumb” for a new game is: If a games visual introduction can't first pass the “eye clutter” and, say the “beer test”, (i.e. the game looks to intimidating) the public most likely won't play, so therefore the game's chances are very slim. And of course, if a game's core Vig-percent advantage is too overbearing the public won't play either, so the game's chances are next to nil!

The Gaming industries foundation formula is:

Hold %=Win % divided by the Drop.

In recent years a large number of “Side-bet” permutations have hit the Blackjack scene. A long view of Blackjack's numbers and performance would well reveal the significant influence of training aids like books & table indexes as well as the impact of computer training aids, and the like video games, have had overtime.

Clearly, training aids have been a significant driving resource used by the public in shaving down the working house Vig-advantage margins of classic Blackjack to such an extent, so as to justify the uptake of so many Side-bet permutations as a means to “re-balance” the customary Drop, Win & Hold percentages of yesteryear, from this perennial Blackjack workhorse.

For you see, this Side-bet trend of the last 25 or so years, has not only been about satisfying player boredom as so many prior-art references state. It has also been about defending the traditional boundaries for which the casino's fixed house percentage advantage in the game had historically operated in the past.

That is, a house Vig-advantage approaching 6% that in resent decades has thinned down to about a 2% Vig, and as low as a −1.5% Vigorish impact against the exceptionally well rehearsed card counter.

As such, Blackjack's core operating Vigorish in the final analysis, has been steadily splintered apart by a progressively wiser yet, still growing player population during the same 25+ year period of time. In the end, it is a good bet, that shear numbers of new players alone will likely not stave off continuing pressure upon traditional Blackjack's core margin.

Why, who knows, maybe just around the corner, casino's might move even more defensively to paying off Naturals at say: Even Money.
Again, as aforementioned, they're already at: 6 to 5. So, what then, is going be the appeal for playing Blackjack?

Finally, there is yet one more hurdle to consider for a successful venture in the gaming business. The “fat enough in the math” hurdle as previously alluded too. Moreover, this hurdle is the “major intersection” of several key issues that are given particular scrutiny, and held foremost, in the minds of housemasters as they do directly pertain to a new game's working house percentage-advantage edge, or Vig.

This hurdle is conceptually known as “Time-In-Play”, or TIP. In the casino business, the house's intentions are to part their customers from as much of their cash as possible, but not so fast as to leave them feeling fleeced or ripped-off. Hence, you might say, even though a game's house advantage must necessarily favor the casino, the more sublime and slower acting the house's Vigorish, the better the opportunity for continuing the public's patronage, whereby the game can ultimately become a valuable asset for housemasters.
Of course, a gambler's TIP, is notwithstanding that gambler doing something really stupid . . .

### BRIEF SUMMARY OF THE INVENTION

As will become quite clear, the applicants' are proffering an embodiment for playing “21”.

But, unlike classic Blackjack/21, the applicants' modified process for play action engages a “No Dealer Hand” approach! Furthermore, for the sake of clarity the terms and depictions being used, as illustrated within the exemplary counsels below are to be construed to substantially comprises the following: “Trigger Numbers”, a.k.a TN's are any single and/or group/set of numbers spanning from: Twelve (12) up to Twenty (20). Another words, any and/or all, can be assigned to function as TN's.

Likewise, optional “Push Numbers”, a.k.a PN's are also assigned play action as any single and/or group/set of numbers spanning from: Twelve (12) up to Twenty (20), as well. While “Winning Numbers”, a.k.a WN's are depicted and assigned to be any single and/or group/set of numbers spanning up to Twenty-One (21).

Similarly, as will be taught, and latter claimed, there exist many possible play action embodiments for culminating the applicants' gaming modifications that are applicable yet, only a few of these embodiments will be sighted for development as more exemplary counsels serving as the necessary disclosure hereto.

Blackjack is the most quintessential table game encompassing the psyche of the world's casino going experience. This is true even if you don't play the game. Almost nowhere, can you go to a casino and not find Blackjack front and center to the play action!

Therefore over the last 25 or so years as new innovations for this perennial favorite have arrived on the scene. It is astonishing that so few, if any, previously taught methodologies for playing classic Blackjack, have never even attempted to addressed the affects of an ever smarter player population that today so astutely exacts such a thinning down effect upon the game's core mathematical dynamic, as sighted above.

Of course, these aforementioned historical observations are notwithstanding the competitive yet, concertedly empirical “rule change” decisions of housemasters' impacting the bottom lines of their own Blackjack games during this same 25+ year period of time as well . . . .

So from the applicants' perspective, there is an alternative to the present day thin-in-the-math circumstance of which classic Blackjack has historically operated. And, as such, their alternative process therefore results in a more mathematically malleable house Vig-advantage working amidst its play. In that, the applicants' balanced modifications deploy a never before applied synergy of “ameliorating consequences” by way of a wider “core margin variance” for casino's to work with.

Similarly, the applicants' methodology of having “no dealer hand” in the game so fundamentally broadens the mathematical margin being applied, by way of the applicants' modifications, that a richer statistical pool is the first ameliorating improvement from their process, whereby allotting for “fatter” payoff ratios, benefiting patrons is provided, without casting strenuous financial effects upon the house or worse yet, chasing off patrons with to strong of a core Vig-advantage.

Most importantly, the applicants' modifications in support of having no dealer hand are by “de facto” the very inducement for the core statistical shift. Likewise, this broader margin is made possible while simultaneously applying a seamlessly familiar playing experience for patrons.

Also, from the player's standpoint, the applicants' modifications remain simple, requiring only routine knowledge, and therefore mental engagement, on the part of patrons to play and enjoy the game. Likewise, patrons no longer face down the Double Bust effect, or the dreaded “Push” on what should have been a winning hand! Furthermore, for the first time in known history, housemasters' can pay a “Blackjack” at: 2 to 1, and multi-card 21's at: 3 to 2, in the same game without going broke . . . .

As such, this significantly more malleable core margin Vig-advantage working within the applicants' “Initial and/or Base” action for play, is a direct consequence of the applicants' insertion of their Trigger Number solution into the process that so ameliorates a player's Time-In-Play too!

Another aspect of the applicants' methodology is the ability of housemasters to “use and manipulate” (i.e. market) the Trigger Number feature as required, whereby further massaging the applicants' gaming process for their casino's financial benefit. Additionally, play actions like Surrender can also be accommodated for, albeit it's application works a little differently than traditional Surrender does. And similarly, as will be shown, a collection of “Ante” type side-bet wagers can easily be made available as housemasters may wish to deploy them.

### OBJECTIVES AND ADVANTAGES

Accordingly, several objectives and advantages are clearly achieved by way of the applicants' method of having No Dealer Hand being applied throughout their process of play. First, regarding the “Table Game” process of play: The applicants' methodology calls for the complete replacement of the “Dealer's Hand” in play. The applicants' accomplish this through means of their Trigger Number affect, again defined as singular, grouped or sets of numbers, typically preceding the Push and/or Winning Numbers, as applied in the applicants' process for play. Trigger Numbers will range anywhere from: 12 up to 20, and can substantially “fluctuate” in their financial impact upon the players at the Base action of the game for a couple of reasons.

One reason being, is due to the way the hands fallout from the shuffling of the cards, or shoe while another reason is more attributable to Trigger Numbers that may bare fluctuating “Vig.” values, as discussed in greater detail further below.

As for the immediate fluctuating impact upon the players when Standing Pat on hand counts of: 12 up to 20, only the practical uses of monetary units (i.e. Chips), along with widely accepted mathematical mechanics, will be the guiding factors in determining the house Vig-advantage edge of a TN selection as there applied from: 12 up to 20, and/or optional PN selections from: 12 up to 20, and typical WN selections of at least 21, in uses by housemasters.

Similarly, as one can already see, several differing yet, cohesive aspects of the applicants' process for play action can arise among this range of numbers as being applied for play action from: 12 to 21, respectively.

For example, if a given casino was to counsel the use of: 17, as their first primary selection of a TN being used, this would leave Standing Pat on every hand count “short” of Seventeen (17), as being “Sacked”.

Meaning the player loses their entire wager while each and every player hand count tally over Twenty-One (21) are Busted, therein losing their entire wagers too.

In even another example, if the housemasters' counsel the Trigger Numbers to be: 16 thru 18, with 19 as a Push Number and 20 & 21 as the Winning Numbers, then all player hands Standing Pat on Fifteen (15) or less, would be Sacked for a complete loss as well, and so on.

As a practical matter, this situation of getting Sacked will typically occur only when a player succumbs to Standing Pat with a hand count short of the established “first” Trigger Number being used, as with a short hand count tally from a weak Double Down action or a weak draw on Split Aces, should players only be allowed One (1) card to Aces.

Again, by definition, a Sacked hand count within the realm of the applicants' process for play, is any hand count that is not Standing Pat upon at least the first Trigger Number, among the selected TN's being applied to the game, whatever they might be. This also includes, the rare final hand count tally of less than Twelve (12).

Therefore, beginning with the dealing of the cards, all players are dealt Two (2) cards, up or down, then starting with the person sitting at first base on the table, each player seeing the value of their present Two (2) card tally, have fast decisions to make. Do they “Surrender”, “Draw” card(s), “Stand Pat”, “Double Down” or “Split” their cards.

Should a player's first Two (2) cards tally to what are typically Winning Number's Twenty (20) or Twenty-One (21), such players are axiomatic winners, and would “Stand Pat” for their winning payoffs.

Nevertheless, should a player's first Two (2) cards tally to what is less than the selected set of Primary Trigger Numbers (i.e. 16-17-18-19) for the table, players may then elect to Surrender and “Stand Off to a Push”, meaning the player does not win or lose, as Surrender is defined, within the applicants' process of play. Although, any established “Ante” wager Side-bets would most likely fall to the house as a consequence of exercising such a Surrender option.

Likewise, the Surrender option may well prove subservient to additional factors like no “back-to-back” Surrender and/or no Surrendering on the “Trigger” range of numbers, in this case 16 up to 19, and/or no Surrender after a third card is drawn.

Regarding a decision to draw cards: Since the applicants' process for “2” play is unique in that if, on the one hand, a players first Two (2) cards tally less than the selected Primary Trigger Numbers (i.e. 17-18), players are then certainly compelled to draw at least One (1) card. This is due to the fact that a players hand count lies in a Socked condition at this point, and therefore will lose their entire wager on any standing tally of Sixteen (16) or less, for this example.

This again assumes the player did not exercise their first Two (2) card Surrender option, which may have been available to them, and is notwithstanding the player drawing to a Sixteen (16) or some other Sock numbers lying in wait to be applied in a Double Down action the players may have made.

Once more, on the other hand, should a player's first Two (2) cards, or any number of cards for that matter, tally to Sixteen (16), Seventeen (17), Eighteen (18), which can often represent a typical set of Trigger Numbers being used for execution of the applicants' game, these players are then “hanging on the Trigger”. Moreover, when players are caught hanging on the Trigger, they may still want to draw at least One (1) card due to the fact that Standing Pat on the Trigger will cause a player to lose a hefty portion of their contract wager presently at risk for the hand. Of course, the risk of Busting over Twenty-One (21) is confronting the players in this circumstance too, which instead would result in the complete loss of their wagers.

### OBJECTIVES AND ADVANTAGES

An additional aspect of the applicants' methodology includes the process of Doubling Down on Ten (10) or Eleven (11) or for that matter any Two (2) cards, should the player wish to risk getting Socked or busting as the circumstance may play out. Similarly, players may Split cards whenever they feel compelled to do so.

Again, notwithstanding those subservient tableside restrictions!

Clearly then, at least within the applicants' Table Game process for play, housemasters' might well provided for the “expansion or retraction” of the TN affect by either including Sixteen (16) or say subtracting Seventeen (17) for example, from the Primary selection of Trigger Numbers being applied. Also, as previously discussed, any totality of Trigger Numbers anywhere from: 12 up to 20, can be used to establish the primary/base action for play application. In addition, housemasters might well see a reason to utilize numbers like Eighteen (18) and/or at least, Nineteen (19) as Push Numbers, instead of using them as just Trigger Numbers.

The Primary Trigger Numbers in uses would then be (i.e. 16-17 or 18) or, maybe just 17 & 18 respectively, along with there “biting Trigger values” for the house. Therefore, in this example, at least 17 & 18 are the primary TN's while 19, is functioning as a PN thereby leaving 20 & 21 as the WN's. Additionally, a “Secondary” selection of Trigger Numbers from: 12 up to 20, could also be used for Double Down actions as well. As such, allowing a Double Down action on Split cards through an expanded range of Secondary Trigger Number's anywhere from: 12 up to 20, could well prove a compelling action for housemasters to take!

Furthermore, it is by this very means of the applicants' Primary and/or Secondary Trigger Number feature along with their manipulations, and the payoffs made on WN's, that the ameliorating power dynamic that so significantly shifts the house advantage margin occurs. Likewise, either of the applicants' aforementioned “Primary or Secondary” selections of TN's, whatever they are established to be, (i.e. 17-18) and (i.e. 16-17-18) respectively are also subject to an “adjustable” percentage affect as well. Meaning, each TN is either subject to the same Vig-advantage affect in it's group number setting for play action, or players may realize a “rising or fading” ladder of percentages effecting each individual number in it's group setting.

For example, say a Primary selection of TN's: 16-17-18, all represent a static 50% loss, or “Vig effect”, upon the players contract wagers when Standing Pat while a Secondary group of TN's effecting Double Down actions might well bare a fading loss, or “Vig effect” like say: 16 @ 60%; 17 @ 50%; 18 @ 40% respectively, or vice versa.

Therefore, it is directly through the applicants' replacement of the classic Blackjack “Dealer hand” method with that of their Trigger Number solution modification that opens up such a significantly improved core margin variance for exploitation, as again aforementioned.

As such, the applicants' core solution provides a “whole new” outlook directly supporting fatter core payoffs from the Initial/base mathematical mechanics for play while still providing for all the necessary elements of a sustainable alternative to the classic Blackjack workhorse for which the public will enthusiastically embrace.

Furthermore, it is the principle objective of the present method for no dealer hand “21” to provide a wholly new gaming process dynamic while requiring only routine mental focus to enjoy a seamlessly familiar playing experience.

It is another principle objective of the present method for no dealer hand “21” to provide a wholly new paradigm of thought provoking play that competently coincides with accepted mathematical mechanics and procedures regarding applied probabilities of chance.

It is another principle objective of the present method for no dealer hand “21” to provide a wholly new adaptation in the form of Primary Trigger Numbers as a base consequence of play action that replaces both the action and function of the now “absent Dealer hand” in play.

It is another principle objective of the present method for no dealer hand “21” to provide for the engagement of Primary Trigger Numbers comprising any numbers from: 12 up to 20, that can be expanded or retracted to affect the house's core margin Vig-advantage from the applicants' process for play.

It is still another principle objective of the present method for no dealer hand “21” to provide for the engagement of optional Push Numbers comprising any numbers from: 12 up to 20, that can be expanded or retracted to affect the available pool of Trigger Numbers supporting the house's core margin Vig-advantage, resulting form the applicants' process for play.

It is still another principle objective of the present method for no dealer hand “21” to provide for the engagement of Winning Numbers comprising; at least 21, that can be expanded or retracted to affect the available pool of both Trigger Numbers and Push Numbers alike supporting the house's core margin Vig-advantage, resulting form the applicants' process for play.

It is still another principle objective of the present method for no dealer hand “21” to provide for the uses of a Secondary set of Trigger Numbers, comprising any numbers from: 12 up to 20, that can be expanded or retracted to affect the subsequent operational “win percentage values” of Double Down actions from the applicants' process for play.

It is still yet another principle objective of the present method for no dealer hand “21” to provide for the engagement of Trigger Numbers & Winning Numbers that can be loosen or tighten for action, on an individual or group percentage basis, thereby supporting a fixed, rising or fading affect for the resulting operational “win percentage values” of such TN's & WN's within the applicants' process for play.

It is still yet another objective of the present method for no dealer hand “21” to provide for a redefined adaptation for Surrender, as an option of play, that functions in play action as a “stand off” solution alternative for an initially dealt Two (2) card Stiff hand or worse.

It is still yet another objective of the present method for no dealer hand “21” to provide for an additional assortment of ancillary “Ante” type side-bet wagers for bonus payoffs, upon the outcome of the first Two (2) cards of a hand being dealt, from which players can choose.

It is yet still another objective of the present method for no dealer hand “21” to provide for an additional assortment of ancillary “Ante” type side-bet wagers for bonus payoffs, upon the outcome of the first Three (3) cards of a hand being dealt, from which players can choose.

It is even another objective of the present method for no dealer hand “21” to provide casinos' with a gaming mechanism that can be manipulated to result in a more sublime yet, ameliorating effect upon a patrons Time-In-Play.

Another consideration regarding the applicants' process for no dealer hand “21”, is to make their gaming modifications available for application into an encompassing electronic video display unit or the like (not shown), whereby a more complete and “sensitive” scale of Trigger Numbers being comprised from: Twelve (12) up to Twenty (20), can be used for either or both of the Primary and Secondary Trigger Number selections being applied, along with the optional Push Numbers being comprised from: Twelve (12) up to Twenty (20), and the Winning Numbers comprising: at least Twenty-One (21), all of which synergize together in play action!

### DESCRIPTION OF DRAWINGS

The foregoing features, advantages, and other objectives of the applicants' methodologies and modifications will become clearly understood from the following flow chart embodiments for progressive events, as taken in conjunction with the accompanying “description of counsels” encompassing any Table gaming, and/or Electronic video gaming display apparatuses being applied, for the same.

FIG. 1 Illustrates the general flow of progressive events to complete a round for the table game version of no dealer hand “21”.

FIG. 2 Illustrates some of the options for a first, Two (2) card ancillary “Ante” type wager side-bets being made available.

FIG. 3 Illustrates some of the options for a first, Three (3) card ancillary “Ante” type wager side-bets being made available.

FIG. 4 Illustrates the detailed flow of progressive events to complete a round for an electronically mechanized version of no dealer hand “21”.

FIG. 5a Illustrates a first exemplary counsel embodiment for play action with their predetermined payoffs.

FIG. 5b Illustrates a continuing first exemplary counsel embodiment for play action with their predetermined payoffs.

FIG. 6a Illustrates a second exemplary counsel embodiment for play action with their predetermined payoffs.

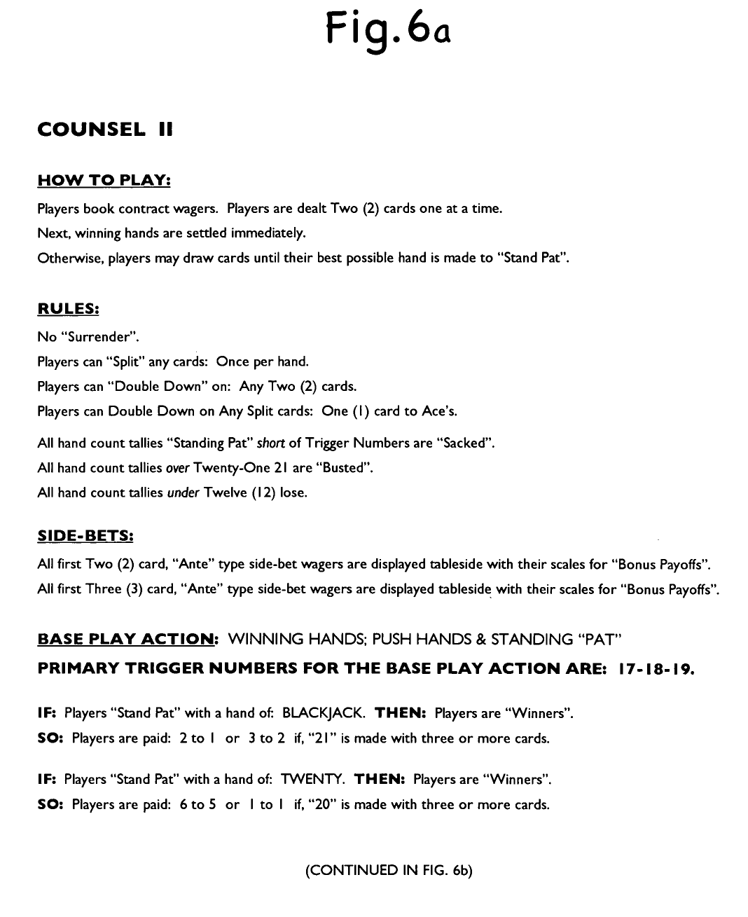

FIG. 6b Illustrates a second continuing exemplary counsel embodiment for play action with their predetermined payoffs.

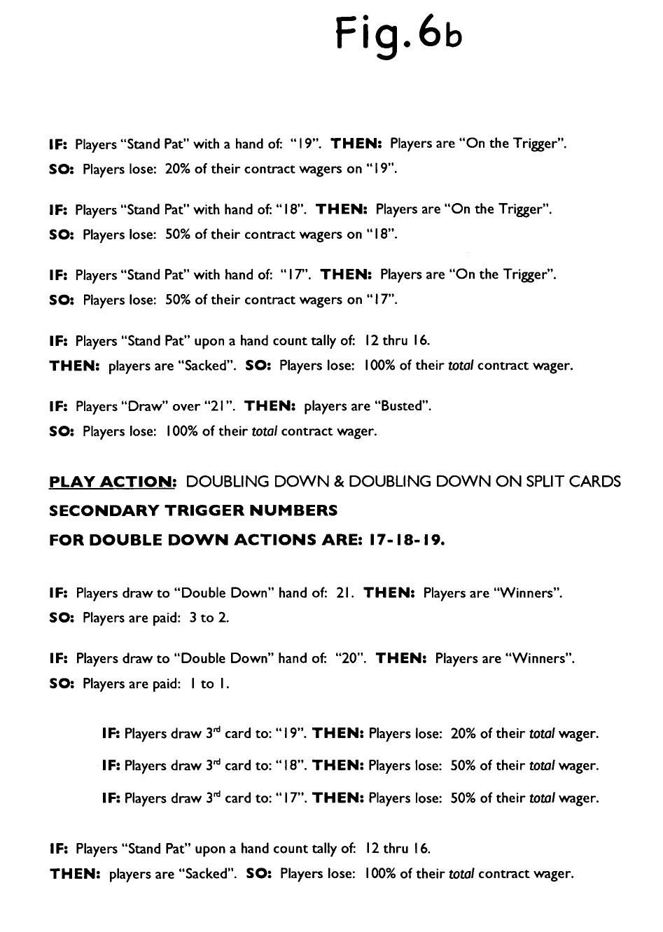

FIG. 7a Illustrates a third exemplary exemplary counsel embodiment for play action with their predetermined payoffs.

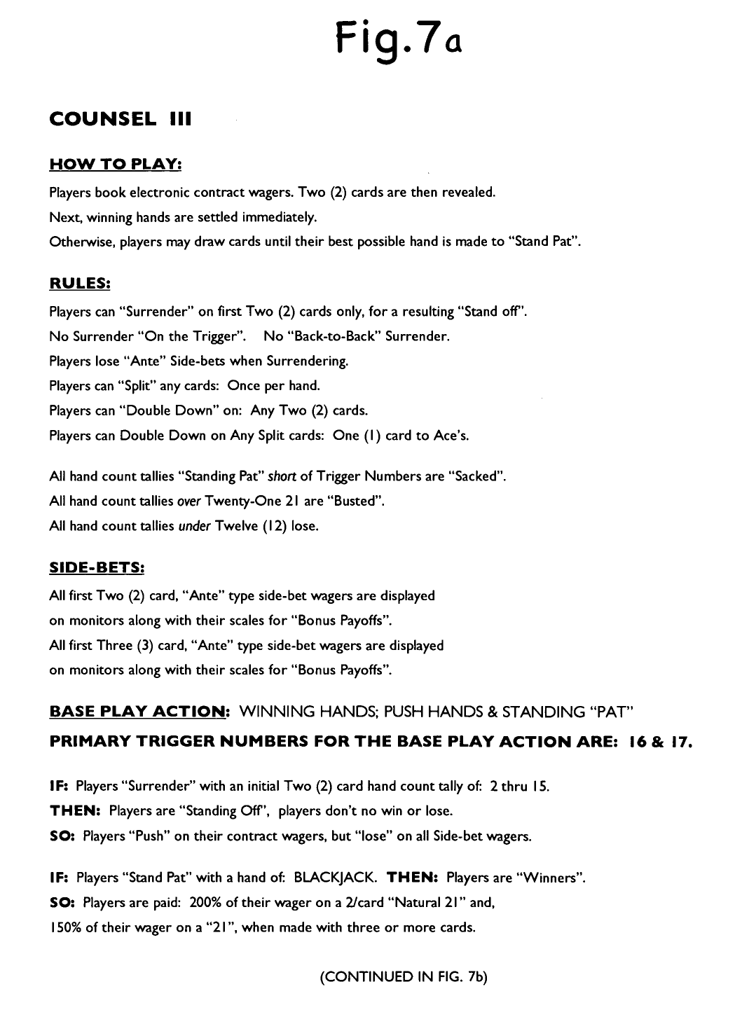

FIG. 7b Illustrates a third continuing exemplary counsel embodiment for play action with their predetermined payoffs.

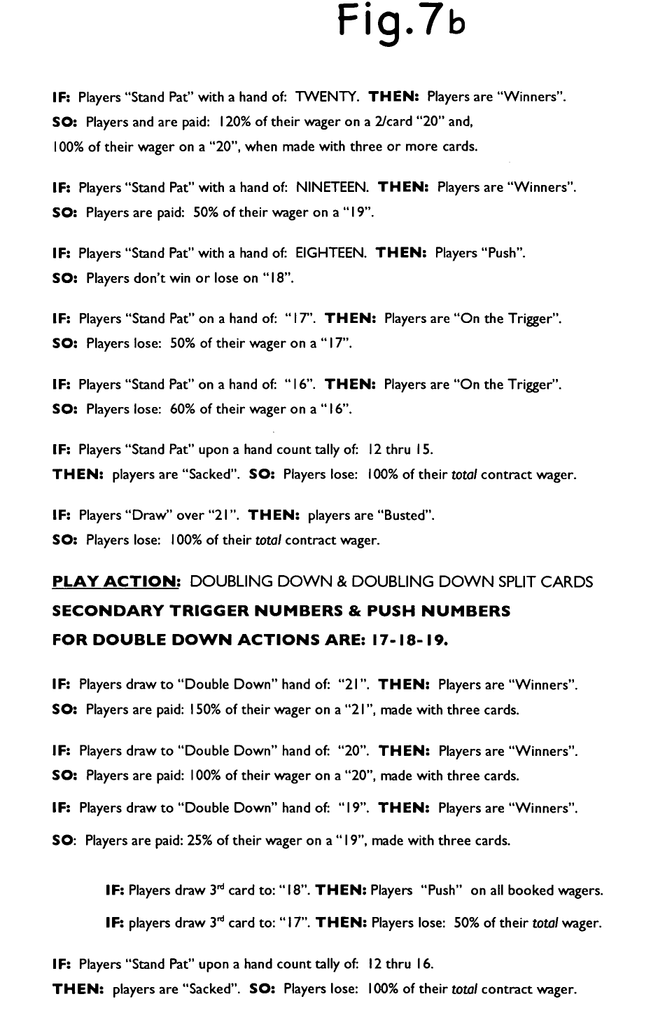

### DETAILED DESCRIPTION OF EXEMPLARY EMBODIMENTS

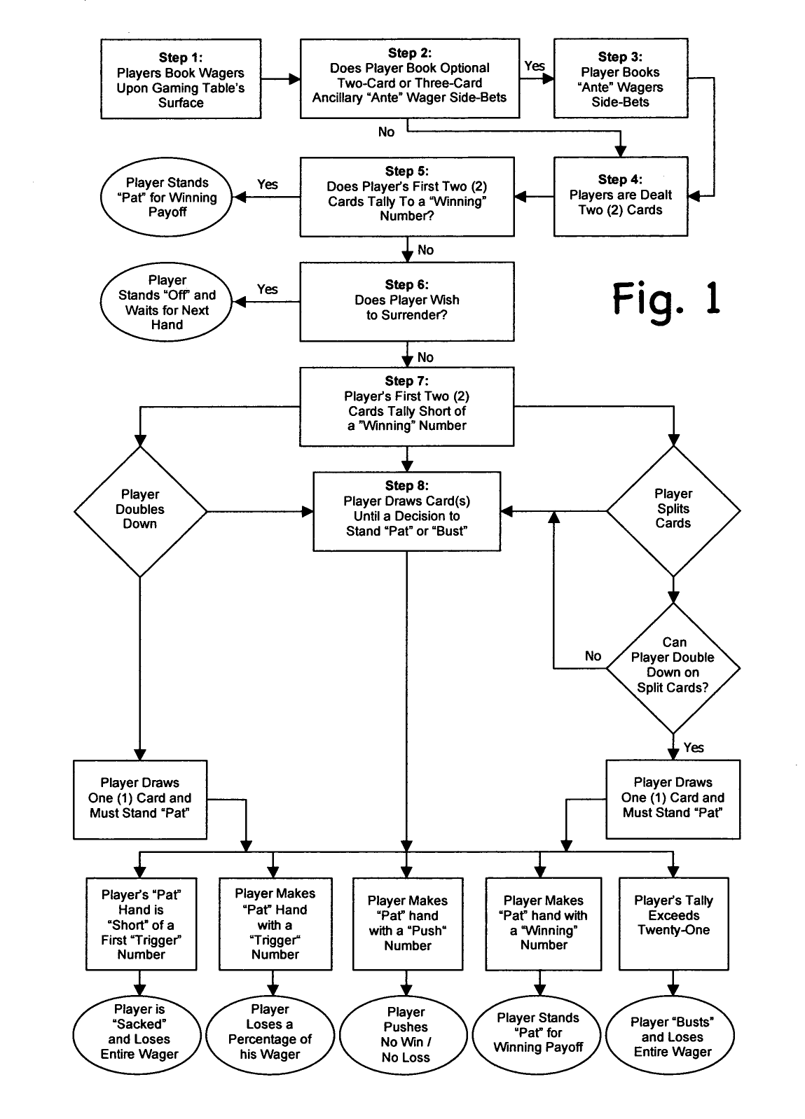

In referring to the drawings as illustrated, it shall be understood that the combined entities of FIGS. 1 thru 7b inclusively are exemplary embodiments of the applicants' gaming methodology. As such, any and all of the Trigger Numbers, Push Numbers and Winning Numbers as selected, discussed and/or illustrated are subject to change at the whim and purpose of the sponsoring organization. This pertains to their numerical associations to one another, and their established Vig-advantages, as assigned by housemasters. Likewise, all methods for public access to the applicants' “no dealer hand” gaming solution, be they “live action”, electronic video, wireless telephonic or otherwise, represent anticipated deployment avenues for this game.

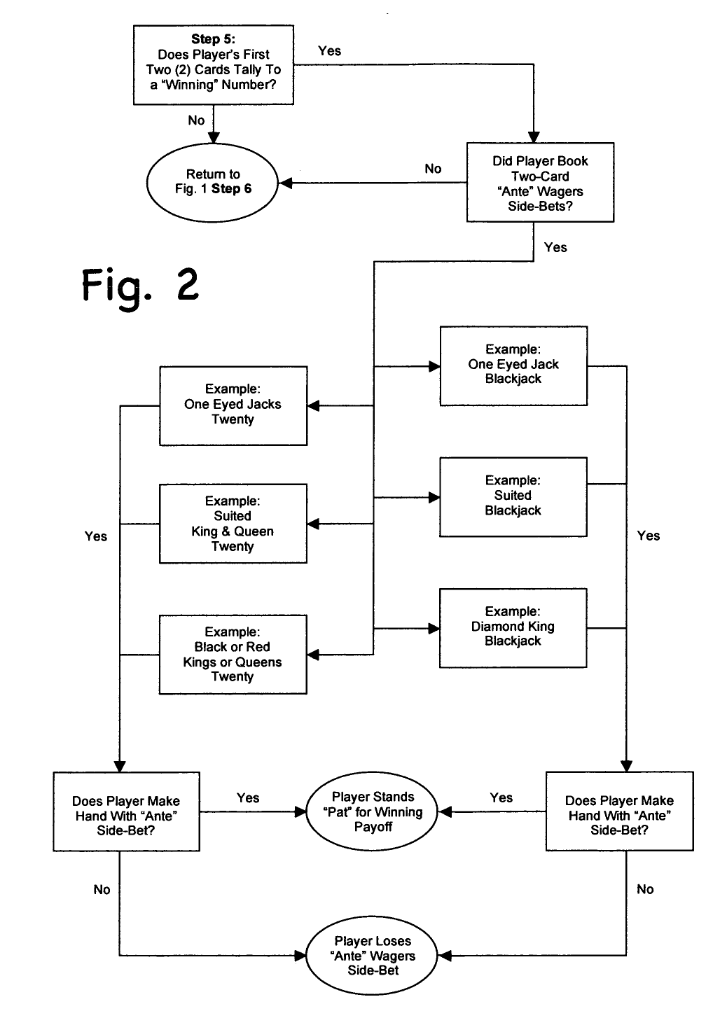

Therefore upon the booking of a required minimum contract wager, and optional “Ante” wager side-bets being offered, a new hand begins with the acquisition of the players first Two (2) cards. Next, each player asses their first Two-cards to discover if a first Two-card winning hand tally exist, including any Two-card winning ancillary “Ante” wager side-bets having been made, as shown in FIG. 2.

If not, then a decision to surrender may be considered should that option be available to the player, as illustrated FIGS. 1 & 4. In the absents of an immediate winning hand count tally outcome, or a desire to surrender their hand, players will likely be compelled to draw at least One (1) card as to at least, avoid being “sacked”.

Furthermore, on the one hand, since the players main motivation is to acquire a winning hand tally of Twenty-One, a player might well bypass other play options drawing cards as they see fit, without Busting, to achieve such ends, as illustrated in FIG. 1. Moreover, on the other hand, the general decision to draw card(s) can come with additional possibilities for players to either Split their cards if, the players holds a pair of equally valued cards usually Aces or Ten cards, Double Down on their cards, assuming their first Two-cards warrant such an action, or both.

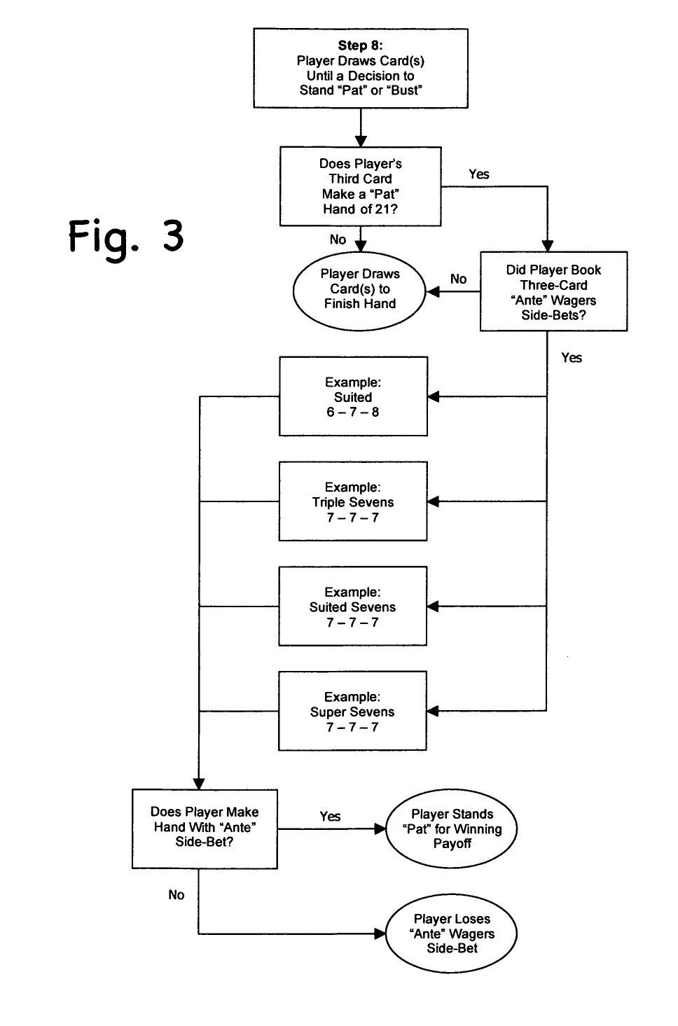

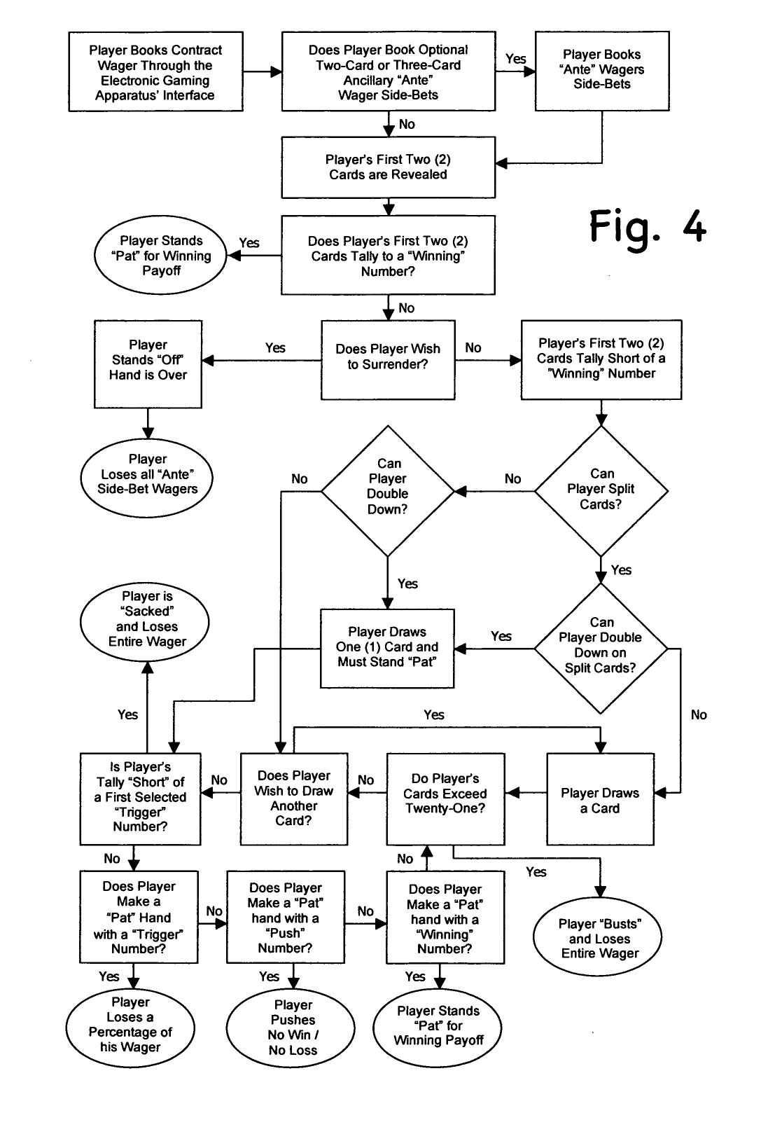

FIGS. 1 and 4, clearly shows the flow of progressive events illustrating the players option to draw card(s) as they see fit without Busting as well as the players incumbent need to “Stand Pat” if, the player draws the One (1) and only card allowed for secondary Double Down actions. Additionally, since a winning hand count tally often shows upon the draw of a third card, play action can also be inclusive to a Three-card ancillary Ante wager side-bet if booked, as illustrated in FIG. 3, respectively

Consequently, FIGS. 1 and 4, also illustrate the circumstances of not acquiring a winning hand. As clearly affirmed; if, a player Stands Pat with a hand count tally “short” of a first Trigger Number being applied to any play action, that is either the Base play actions, or a secondary Double Down action, then players are “Sacked”, and lose their entire contract wager as well as any ancillary Ante wager side-bets for the hand they may have booked.

Or, if a player Stands Pat upon a hand count tally of a Trigger Number being applied, such players will lose a hefty percentage portion of their contract wagers at risk. And, if players Stand Pat on a hand count tally of an optional Push Number being applied, such circumstance resolve the player's hand count tally as a “Push”, again meaning a no win, no lose outcome for the hand. Therefore, leaving all Winning Number outcomes to be awarded according to their predetermined payoffs.

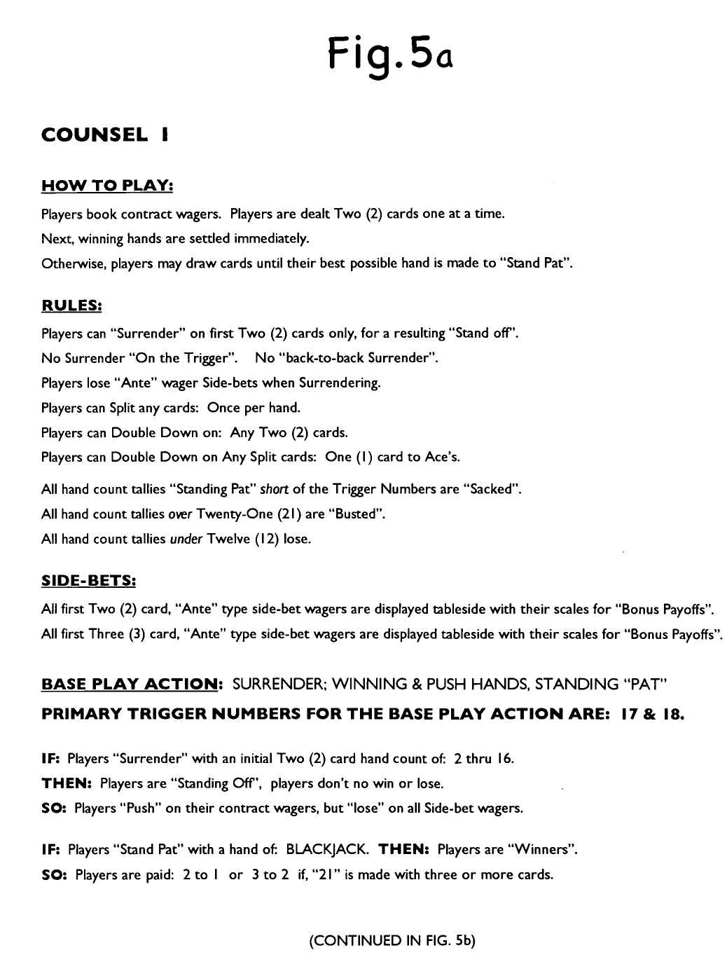

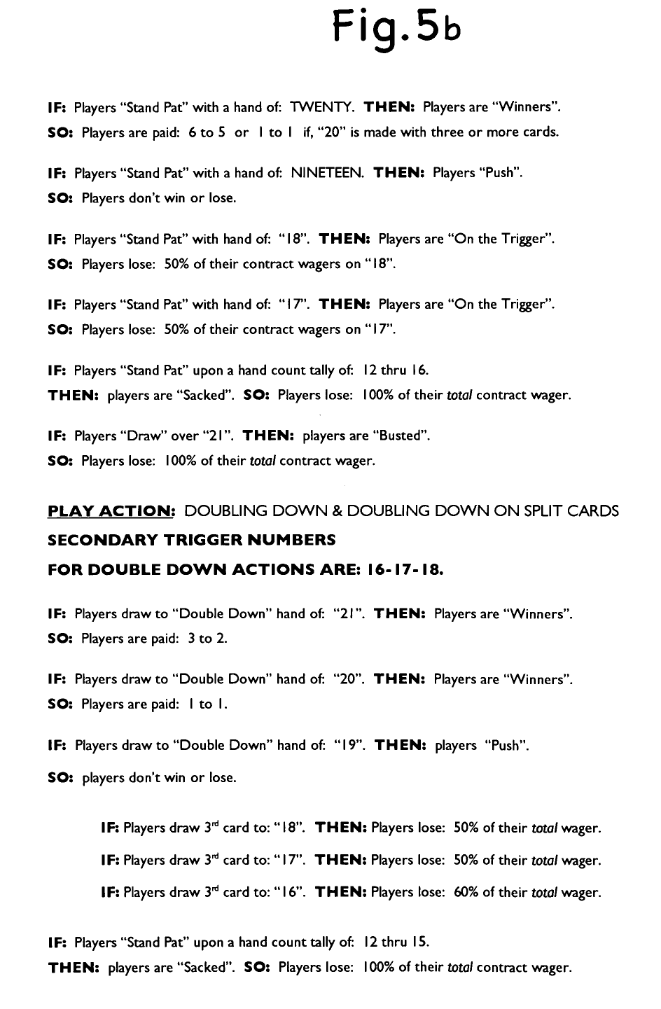

Finally, FIGS. 5a thru 7b respectively, provide exemplary counsel embodiments that unequivocally guide the applicants' intentions for general play action of their no dealer hand “21” methodology.

### OPERATIONAL ADVANTAGES

Suffice to say, there has never been the ability to establish such a generous payoff schedule within the core mathematical boundaries of classic Blackjack. Not to mention such a payoff schedule being promulgated by way of the very core margin from a new solution for which classic “Dealer-Hand Blackjack” methodologies could never have envisioned, accommodated or sustain!

As illustrated, the applicants' methodologies and modifications unlike others coming before it provides a significant 50% increased payoff for a Winning Number outcome of Twenty-One. That is, both outcomes of either a Two-card “Natural” 21, or a multi-card 21, respectively while optional Push Numbers represent a zero sum loss to the players, and Standing Pat upon applicable Trigger Numbers “never results in the total loss” of a player's contract wager having been made.

Regarding the electronic modifications for play: Additional advantages of the applicants' process for playing no dealer hand 21 will become operational through the encompassing means of an interactive video gaming apparatus as provided for the game. In considering the applicants' modifications, as applied to an electronic process for play, a “broader scale” of TN's, PN's & WN's can be utilized, due to the fact that in video mode the applicants' gaming process is engaged into a “real time computing environment” wherein the issuance of monetary units (i.e. chips) and therefore their valuations are not constricting upon the play-by-play action of the applicants' process for play.

Meaning there are no human factors slowing the game to figure out what can now be a more “sensitive fractional deduction or addition” to a players wager, when a decision to Stand Pat on the Trigger for example is made, and no human mistakes in calculating them are possible either! Therefore, a perfectly worthwhile process for engaging the applicants' gaming modifications to the public will be provided through the application of the “singularly intimate” means of an electronic video display, wireless telecommunications device, or the like.

In so doing, the aforementioned broader scale of Trigger Number's, and/or Push Number's & Winning Numbers could span a plurality of numbers comprising any numbers from: 12 up to 21, in a most sensitively balanced manner.

As such, the Trigger Number affect upon the player within the bounds of an electronic version of the applicants' gaming methodology could for example, encompass player exposures of: 100% loss on all “Pat” hands under Twelve (12); 100% on 12; 100% on 13; 80% on 14; 60% on 15; 50% on 16; 60% on 17 for wagers at risk. While players “Push” on: 18. And, “Win”: 20% on 19; 120% on 2/card 20; 100% on 3/card 20; 150% on Natural 21 & 120% on 3/card 21 for wagers at risk or any plurality mixture being applied.

Once more, another example could easily comprise the uses of Primary Trigger Numbers: 12, 13, 14, 15, 16 & 17. The Push Numbers of: 18 & 19. And the Winning Numbers of: 20 & 21 or again, any plurality mix of numbers and percentages thereof, respectively which all synergize together for manipulative play! Similarly, there would be an entire secondary selection of TN's, PN's & WN's, working amidst all Double Down play actions as well.

Another “value added” aspect of the video application process is the ability to string any number of video units together, across any geographical locality, supporting any number of ancillary “Ante” type Side-bet wagers and/or batteries of progressive “jackpot” opportunities too!

Most notably, the applicants' TN, PN & WN process of play provides for a key unexpected benefit for both players and casinos alike, wherefore a credible balance between the casino's necessary house Vig-advantage and a player's exposure to it is definitely made a palatable one.

This is directly due to the ameliorating manipulations of the applicants' Primary and/or Secondary Trigger Number selections and/or group/sets, Primary and/or Secondary Push Number selections and/or group/sets as well as the Winning Number selections and/or group/sets as has been thoroughly described and illustrated above, therein producing a ready potential for much improved payoff ratios from this new core mathematical dynamic . . . .

As for the gaming industry, casinos can once again offer their patrons an exciting option to classic Blackjack that is simple to grasp, and will prove to be even more generous to their patrons Time-In-Play.

Likewise, the applicants' process of play either in it's table gaming format or it's interactive electronic format provides a solution that not only supports richer incentives for patrons play action but, the applicants' methodology will likely simultaneously propagate a significantly “fatter” Win % value for housemasters as well. Another significant result of the applicants' process for no dealer hand 21, works to restrain the effect of card counting by “directly frustrating” the practical functionality of known card counting techniques and strategies due to the direct extraction of the Dealer hand “affect” upon the game.

To appreciate this, is to know that the player's relationship to the cards is now solely a “static” one, to the Six (6), Eight (8) or whatever number of decks shoe is in uses, and not to the Dealer's hand “affect”, directly. An affect, that represents the most salient purpose for, and focus upon, essentially every effective card counting system known.

Moreover, from the player continuum perspective, the applicants' featured solutions advocating a “no dealer hand” play action approach to the game, at long last, satiates the single greatest long suffering problem engulfing the play of classic Blackjack, that long suffering problem being, the players' chances of surviving the continuum's unending on-slot of “detestably hot” Blackjack Dealer hands!
Because now, there simply isn't one . . .

### PREAMBLE TO THE CLAIMS

Accordingly, the present invention has been described with respect to specific methods & modifications, and some effective counsel embodiments. Likewise, it will be understood that various changes and further modifications will be suggested by those skilled in the art. Therefore, it is the intent of the applicants' to anticipate such changes and modifications as falling within the scope of the appended claims.

We claim:

1. A method for playing twenty-one, having no dealer's hand in play action while engaging the use of at least one common deck of fifty-two cards, resulting in the provision of a more mathematically malleable core margin variance, comprising the steps of.
(a) allowing players to make an initial base contact wager for play action;
(b) allowing said players to make additional ancillary ante-type wagers for play action;
(c) dealing all said players two-cards for an initial two-card hand count tally of up to twenty-one;
(d) settling all first two-card winning hand count tallies according to their predetermined payoffs;
(e) allowing said players to split their said initial two-card hand tally, before taking additional cards, for playing out the hand of their said base contract wagers for play action;
(f) allowing said players to double down on their said initial two-card hand count tally, before taking an additional card, for playing out the hand of their said base contract wagers for play action;
(g) having said players without said first two-card winning hand count tallies, to draw at least one additional card to avoid being sacked, for a complete loss with a hand count tally of less than a first trigger number being used, from a first primary selection of trigger numbers being applied, for play action;
(h) having said players without said first two-card winning hand count tallies, to draw said at least one additional card, to avoid standing pat with a push number hand count tally, of a first push number being used, from a first primary selection of push numbers being applied, for play action;
(i) settling all winning hand count tallies of three or more cards according to their said predetermined payoffs;
(j) settling all busted hands over twenty-one, as a complete loss for the players said base contract wager for the hand;
(k) having said players standing pat upon said hand count tally, of at least a said first trigger number being used, from said first primary selection of trigger numbers being applied, to the base action of play, lose a hefty portion of their said base contract wager for the hand;
(l) settling all winning double down hand tallies according to their said predetermined payoffs;
(m) having said players standing pat upon said hand count tally, of at least a said first trigger number being used, from a secondary selection of trigger numbers being applied, in completion of a double down action, lose a hefty portion of their said base contract wager for the hand;
(n) settling all sacked hands short of said first trigger number being used, as a complete loss for the players said base contract wager for the hand.

2. The method of claim 1, further includes said additional ancillary ante-type wagers, of step (b) as being, both a first two-card, and a first three-card outcomes for a hand.

3. The method of claim 1, further includes said initial two-card hand tally, of step (e) as being, any equally valued pair of cards.

4. The method of claim 1, further includes said double down of their said initial two-card hand count tally, of step (f) to substantially comprise, any two-cards for play action.

5. The method of claim 1, further includes said first primary selection of trigger numbers being applied, for play action of step (g) to substantially comprise, a plurality of numbers ranging from twelve to twenty.

6. The method of claim 1, further includes said first primary selection of push numbers being applied, for play action of step (h) to substantially comprise, a plurality of numbers ranging from twelve to twenty.

7. The method of claim 6, further includes said first primary selection of push numbers being applied, for play action of step (h) as all being, optional.

8. The method of claim 1, further includes the loss of said hefty portion of their said base contract wager, of step (k) to substantially comprise, any amount short of a total loss of the player's said base contract wager.

9. The method of claim 1, further includes the loss of said hefty portion of their said base contract wager, of step (m) to substantially comprise, any amount short of a total loss of the player's said base contract wager.

10. A method for establishing a modified no dealer hand twenty-one gaming process using at least one common deck of fifty-two cards for application to a wholly new play action concept, resulting in the provision of a more mathematically malleable core margin variance directly benefiting housemasters and players thereof, comprising:
a gaming process utilizing at least one common deck of fifty-two cards for uses in a no dealer hand process for twenty-one play action;
said gaming process having each player establish an initial base contract wager to play the game;
having said each player receive an initial two-cards to establish an initial first two-card hand count tally of up to twenty-one for play action;
awarding all first two-card winning hand count tallies according to their predetermined payoffs;
having said each player asses their said initial first two-card hand count tallies for a decision to stand pat or draw additional cards for pursuing play action;
said gaming process, having said no dealer hand, engaging the uses of a trigger number means as a practical solution in place of a dealer's hand amidst play action;
also, said gaming process, having said no dealer hand, engaging the uses of an optional push number means as an additional practical solution in place of said dealer's hand amidst play action;
settling all said hand count tallies, busting over twenty-one, as wins for the house;
awarding all said winning hand count tallies of three or more cards, according to their said predetermined payoffs;
settling all sacked hand count tallies, short of the first trigger number being used, as wins for the house.

11. The method of claim 10, further includes having said each player receiving said initial two-cards for establishing said initial first two-card hand count tally, an ability to surrender said initial first two-card hand being applied, in play action.

12. The method of claim 10, further includes said decision to draw additional cards for pursuing play action, as continuing said play action, through the splitting of cards for play action, and doubling down on cards for play action, to complete a hand of play.

13. The method of claim 10, further includes said first two-card winning hand count tallies, as also applying to ancillary ante-type side bet wagers, being made in play for said first two-cards being revealed, with their said predetermined payoffs.

14. The method of claim 10, further includes said trigger number means to substantially comprise, a plurality of numbers from twelve up to twenty.

15. The method of claim 10, further includes said optional push number means to substantially comprise, a plurality of numbers from twelve up to twenty.

16. The method of claim 10, further includes said winning hand count tallies of three or more cards, as also applying to said ancillary ante-type side bet wagers being made in play for said three or more cards being revealed, with their said predetermined payoffs.

17. An electronically mechanized gaming process for playing a modified game of twenty-one having no dealer hand in play action while such modified gaming process is encompassed within an electronic gaming apparatus utilizing an electronic simulation of a common deck of playing cards for play of the same, all of which results in the provision of a new core margin solution directly supporting both significantly increased payoffs as well as time-in-play for players, comprising:
a modified gaming process encompassed within an electronically mechanized gaming apparatus, displaying an electronic simulation, of a common deck of fifty-two playing cards providing a singularly intimate electronic gaming process for playing a game of no dealer hand twenty-one;
with, said singularly intimate electronic gaming process utilizing said electronic simulation of said common deck of fifty-two playing cards therein, displaying a first two-cards of an initial two-card hand count tally of up to twenty-one;
also, having said singularly intimate electronic gaming process operating within said electronically mechanized gaming apparatus displaying said first two-cards of said initial two-card hand count tally of up to twenty-one, awarding all first two-card winning hand count tallies being revealed, according to their predetermined payoffs;
said singularly intimate electronic gaming process allowing players to draw additional cards for pursuing further play action of the game;
with, said singularly intimate electronic gaming process having a trigger number means being used, from twelve up to twenty replacing a dealer's hand, in play action;
and, said singularly intimate electronic gaming process allowing for players to draw at least one additional card for making a hand count tally that avoids being sacked by a hand count tally of less than a first primary trigger number selection being applied, in play action;
also, said singularly intimate electronic gaming process having an optional push number means being used, from twelve up to twenty replacing said dealer's hand, in play action;
with, said singularly intimate electronic gaming process allowing for said players to draw at least one additional card for making said hand count tally that avoids being pushed by said hand count tally of an optional first push number selection being applied, in play action;
also, said singularly intimate electronic gaming process operating within said electronic gaming apparatus, awarding all winning hand tallies of three or more cards being revealed, according to their said predetermined payoffs;
with, said singularly intimate electronic gaming process, settling all busting hand count tallies, over twenty-one, as wins for the house;
and, said singularly intimate electronic gaming process, settling all sacked hand count tallies, short of said first primary trigger number selection being applied, as wins for the house.

18. The method of claim 17, further includes said electronic gaming process, as utilizing a secondary trigger number selection being applied, from twelve up to twenty for the manipulation of double down play actions.

19. The method of claim 17, further includes the displaying of said first two-cards for said initial two-card hand count tally as also applying to ancillary ante-type side bet wagers being made in play for said first two-cards being revealed, with their predetermined payoffs.

20. The method of claim 17, further includes the displaying of winning hand tallies of three or more cards as also applying to ancillary ante-type side bet wagers being made in play for the first three cards being revealed, with their predetermined payoffs.
